(19) United States
(12) Patent Application Publication
(10) Pub. No.: US 2014/0040928 A1
(43) Pub. Date: Feb. 6, 2014

(54) AUDIENCE POLLING SYSTEM

(71) Applicants: William Frederick Thies, Bangalore (IN); Andrew C. Cross, Dallas, TX (US); Edward B. Cutrell, Bangalore (IN)

(72) Inventors: William Frederick Thies, Bangalore (IN); Andrew C. Cross, Dallas, TX (US); Edward B. Cutrell, Bangalore (IN)

(73) Assignee: MICROSOFT CORPORATION, Redmond, WA (US)

(21) Appl. No.: 13/565,043

(22) Filed: Aug. 2, 2012

(51) Int. Cl. H04N 21/24

(52) U.S. Cl. 725/10

(57) ABSTRACT

A system for acquiring feedback from an audience, such as a group of participants in an educational class or a business meeting. The system includes a camera that is controlled to capture an image of the group of participants. Each participant may be provided with a set of encoded objects that both reflect responses that can be selected by the participant and the identity of the participant. These objects may be encoded with a pattern that facilitates computerized recognition in the image of the response selected by the participant and participant identifier. Based on information acquired from the image, the system can automatically, or with user input, analyze responses from the group of participants.

### BACKGROUND

In educational, business and social settings, feedback is sometimes collected from a group of participants in a class, meeting or other group. Various techniques have been used to obtain such feedback, including talking to the participants, asking the participants to raise their hands to show agreement or disagreement, or providing the participants with an input device through which they can provide feedback.

Various uses may be made of the feedback. The feedback in an education setting, for example, may be used to assess whether a class as a whole or individual participants understood the concepts of a lesson. In a business or social setting, for example, feedback may be used to build consensus around an action plan.

### SUMMARY

A low cost, yet effective, way to obtain feedback is provided through a computer vision system that can collect responses from coded objects manipulated by participants in a class, meeting or other group. Each of the objects may be encoded to indicate a response such that a participant may select an object to face towards a camera of the computer vision system to indicate a desired response. Alternately, each of the objects may be encoded to indicate a unique identity, and the participant's selected rotation of the object facing the camera may encode a response.

Each object may be encoded such that the response of a participant is not readily apparent to other participants, even if the other participants can see the object selected by that participant. In some embodiments, the responses may be encoded differently for different participants. In some embodiments, each participant may have an identifier, and the encoding of responses on objects used by a participant may be based on the identifier for that participant. In some embodiments, each participant may have an identifier, and the encoding of responses on objects used by a participant may be based on the relative rotation of the object for that participant, which may be unique from other objects to preserve anonymity. In this way, each participant may have access to a set of objects that each indicates a response of a plurality of responses. A participant may indicate a response by selecting an object from the set and presenting it towards a camera.

Encoding enables analyses to be performed on an image depicting a group of participants from which feedback is to be obtained. The analysis, for example, may represent an aggregate of responses of the group. Alternatively, responses, including the lack of any selection of an object, by individual participants may be determined.

In some embodiments, the objects may be encoded in a way that facilitates analysis by a computer vision system. For example, objects may contain one or more “targets” having visual characteristics that allow the computer vision system to recognize such objects with high confidence. In some embodiments, each object may be encoded with a pattern of such targets. Such a pattern may increase the confidence with which a computer vision system recognizes an object conveying feedback. Moreover, the object may have a region, encoded with a response and/or a participant identifier that has a predetermined position and/or rotation with respect to the pattern of targets. Such encoding may facilitate more accurate identification of objects conveying feedback and determination of the specific feedback conveyed by each object.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch of an environment in which an exemplary embodiment of a feedback system may be employed;

FIG. 2 is a block diagram of an exemplary embodiment of a feedback system;

FIG. 3 is a sketch illustrating an exemplary encoding scheme for an object usable by a participant to present feedback;

FIGS. 4A and 4B are sketches of processing of an object by a feedback system;

FIG. 5 is a flowchart of an exemplary method of operation of a system for collecting and analyzing feedback; and

FIG. 6 is a sketch of an exemplary computing system on which all or parts of feedback system may be implemented.

### DETAILED DESCRIPTION

The inventors have recognized and appreciated that feedback may be inexpensively, yet accurately, obtained from a group using a computer vision system and objects encoded to represent responses by participants in the group. Objects encoded in this fashion may have unique encoding for each participant, even when the same response is to be given. As a result, the tendency of some participants to copy the responses of others in the group is substantially suppressed—leading to a more accurate feedback system.

The inventors have recognized and appreciated that encoding of responses enables participants reluctant to provide feedback, possibly because of embarrassment over selecting a wrong answer to a question or otherwise providing feedback that is not accepted by others in the group or the group at large to participate in a group setting. For example in an educational setting, the anonymity provided by such a system may encourage shy students to participate—even in a large group where peer pressure can impact feedback provided.

Encoding of individual identifiers into objects used to signify responses allows responses to be analyzed to generate useful information. Analyses of the responses may allow aggregation of responses such that the overall sense of the group of participants may be obtained. Though, encoding with individual participant identifiers also allows analysis of individual feedback. Such a capability may be used in an educational setting, for example, to assess whether an individual student failed to grasp concepts understood by the class at large so that teaching resources may be allocated appropriately. Such a capability may be particularly important in resource constrained schools with large classes and few teachers.

As used herein, an “object” used by a participant may have any suitable form. In some embodiments, different surfaces of a single structure may be encoded differently, such that each encoded surface may be a different object for purposes of expressing a response. For example, in some embodiments, the objects may be a set of printed response cards, with each card having printed on in it information representing a response and an identifier of the participant holding the response card.

A camera may be positioned in front of the participants to recognize and aggregate the responses indicated by the participants. The camera may be any suitable imaging device(s) that may be used to capture an image of the participants' responses, including a computer and webcam, or a mobile phone with integrated camera or video recorder. It should be appreciated, however, that the exact nature of the imaging device(s) is not critical to the invention.

As used herein, an “image” may be in any suitable form. The image may be a still photograph, depicting the entire audience or other group of participants from which feedback is to be collected. Though, in some embodiments, multiple still photographs, with different photographs depicting different portions of the group of participants and/or depicting the group of participants from different orientations such that multiple still photographs provide an image of the group. As yet another possible implementation, the image may be acquired from a video clip of the group. Accordingly, it should be appreciated that the invention is not limited by the nature of the image of the group of participants.

Once an image of the group of participants has been captured, it may be processed by any other suitable computing device. To facilitate processing of the image, in some embodiments, objects signifying responses may have particular patterns of shapes and/or colors that can be recognized and decoded by an algorithm, regardless of tilting or skewing of the cards in an image. Such a system can facilitate the robust identification and decoding of the information on the cards, despite any non-ideal positioning, orientation, and rotations of the captured images.

In some embodiments, the objects may be responses cards, and each response card may have printed on it different regions, including a region with a predetermined pattern that may be used to identify the card and locate information on the card. The card may also have an encoded portion that encodes both a response and an identifier of the participant holding the card. Each participant may have a plurality of such response cards, with the encoded portion on each card encoding a different response for that participant. Alternately, the encoded portion may solely identify the participant, and the orientation of the response card may indicate the participant's response. Each card may have a unique rotation to response mapping such that viewing the rotation of another participant does not reveal their response.

In some embodiments, once an image of the group of participants with their respective response cards has been captured and analyzed by an imaging device, a graphical representation of the responses may be generated. For example, the graphical representation may be a statistical chart, or other suitable pictorial summary, based on the aggregated responses. Though, it should be appreciated that analysis need not entail aggregation of results for multiple participants. Analysis could be performed on individual participants based on responses that they provided or did not provide. The graphical representation may be displayed to an administrator of the system, who may then use this information to customize or adapt the presentation in real-time.

Alternatively or additionally, a graphical representation of the participants' feedback may be displayed directly back to the participants. For example, a projector may display a summary of participant feedback, including who has yet to provide any feedback. In some embodiments, feedback presented to the participants may also encourage more interactivity with the participants, for example, by having participants choose cards to vote on the progression of an interactive story, or to interact with a virtual tutor.

In addition or as an alternative to displaying in real-time the feedback collected from the participants, in some embodiments, the feedback may be stored for later review and analysis. For example, digitized responses of the feedback may be archived and used for evaluating participants and assessing their progress, although the invention is not necessarily limited to using the saved feedback for any particular purpose.

As used herein, “feedback” may be in any suitable form. Feedback, for example, may be provided directly in response to a question. In some embodiments, the question may be posed with multiple enumerated choices for response. The feedback may be in the form of an indication of which of the multiple enumerated choices has been selected by a participant. Though, in other embodiments, participants may be able to select objects representing current feelings, emotion or other attitudes, and the participants can express those attitudes at any time by presenting an object, encoded to represent a particular attitude, towards the computer vision system. By monitoring an image of the group, the computer vision system can obtain information about a current attitude of the group in general or individual participants, which may also be a form of “feedback.”

Likewise, a “response” may be in any suitable form. In some embodiments, a “response” may indicate a selected answer to a question, such as a multiple choice question. Though, in some scenarios, the response may indicate a participant's reaction to, feeling about, impression of or other indication of an individual state related to anything associated the group of participants. Non-limiting examples of such state include like or dislike, such as for an instructor of a course or topic discussed, or physical comfort, such as being too hot or too cold. Accordingly, it should be appreciated that the invention is not limited by the types of “responses” measured by the system.

Following below are more detailed descriptions of various concepts related to, and exemplary embodiments of, methods and apparatus according to the present invention. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein. Further, while some embodiments may be described as implementing some of the techniques described herein, it should be appreciated that embodiments may implement one, some, or all of the techniques described herein in any suitable combination.

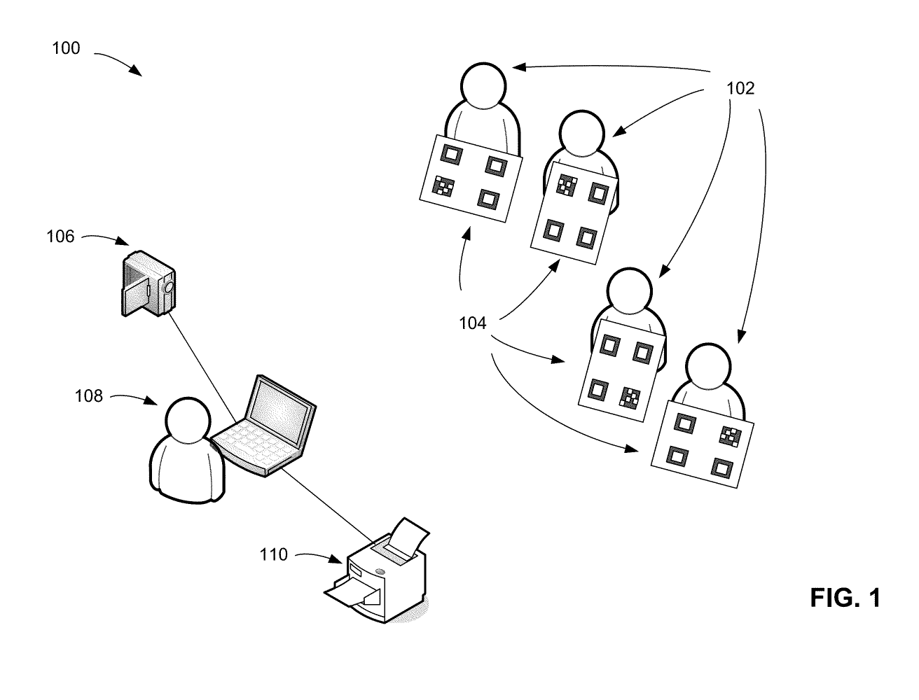

FIG. 1 is a sketch of an environment in which an exemplary feedback system 100 may be used to collect feedback from participants 102. Each of the participants 102 may be given objects with which to indicate their responses. For example, the objects may be response cards 104. In some embodiments, each of the response cards 104 may be encoded with information indicating both a response and an identifier for the participant holding the card. In some embodiments, each of the response cards 104 may be encoded with information indicating an identifier for the participant holding the card, and encode a response in the rotation of the card. The participants 102 may indicate their responses by physically holding up the appropriate cards 104.

As a simple example illustrating one possible embodiment, each of the participants 102 may have three different cards, each card indicating one of three responses, such as A, B, or C for a multiple choice response. In response to a question or any other suitable prompt, each of the participants 102 may hold up an appropriate card indicating an answer. In another possible embodiment, each of the participants 102 may each have a single card, where the four discrete rotations of the card represent multiple choice responses A, B, C, or D. In response to a question or any other suitable prompt, each of the participants 102 may hold up their card in an appropriate orientation indicating an answer. It should be appreciated, however, that the invention is not limited to any particular number of participants or possible responses.

The responses from the participants 102 may then be captured in the form of an image by one or more imaging devices, such as a camera 106. In some embodiments, the camera 106 may be a webcam attached to a computer or an integrated camera in a mobile device such as a phone. It should be appreciated, however, that any suitable imaging device or combination of imaging devices may be used to capture the participant responses. Regardless of the exact nature and number of the imaging device(s), a camera 106 may scan the participants 102, identifying their response cards 104 and reading the printed encodings to determine the participants' responses.

The captured image may then be analyzed to generate a graphical representation of the responses of the participants 102. In some embodiments, the graphical representation may be a statistical graph or any other suitable visual summary of the aggregated responses. The graphical representation may be displayed on a computer to be viewed by an administrator 108, such as a teacher or proctor. Alternatively or additionally, the summary may be provided on another output device, such as a printer 110, or displayed back to the participants 102.

Although FIG. 1 illustrates a scenario in which the participants 102 are in the same physical location as an administrator 108, such as a classroom or other gathering place, the invention is not limited to such settings. For example, in some embodiments, such as a long-distance teleconference or a virtual classroom lecture, the participants 102 may be at a different location than the administrator 108. In such scenarios, images of the participants' responses may be aggregated via a communication link, such as in a remote teleconference, to create an overall image for analysis.

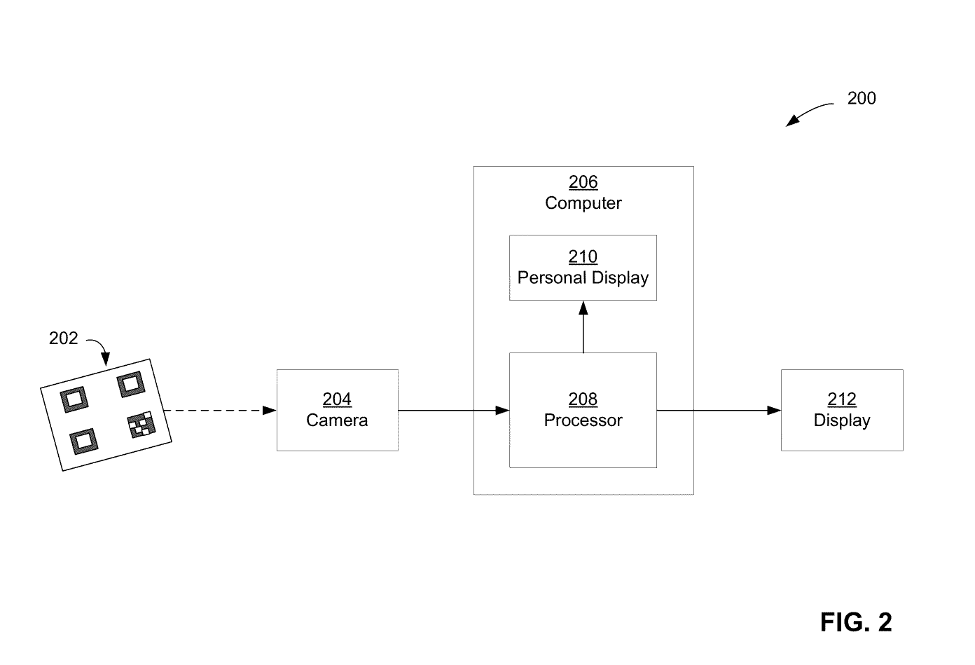

FIG. 2 is a block diagram of an exemplary embodiment of a feedback system 200. An object, such as a response card 202, indicating feedback from a participant may be imaged by camera 204. The camera 204 may represent a single camera, or may be a combination of suitable image capturing devices. Each image may capture a single response card 202 or a plurality of response cards. Regardless of the exact nature of the camera 204, one or more images of a response card 202 may be sent to a computer 206.

The transmission of images from camera 204 to computer 206 may be performed by any suitable communication mechanism. For example, the transmission may be performed by wired or wireless links. In some embodiments, computer 206 may be at a location remote from camera 204, in which case the transmission of images may be performed over a wide area network, such as the Internet. In some embodiments, the images may be physically transferred from camera 204 to computer 206 via a removable storage medium.

Regardless of the exact nature of transferring images from the camera 204 to computer 206, the images may be analyzed using a processor 208. The processor 208 may execute an algorithm to analyze the images and extract information about the responses contained therein. In some embodiments, the processor 208 may first identify the location of a card within the captured image, and then locate relevant information printed on the identified card. Once this information is located, the processor 208 may decode the information to determine a response and an identifier of a participant holding the card 202.

The decoded information on the card 202 may then be used to determine aggregated responses of all the participants. Alternatively or additionally, individual responses, including the lack of a selection of an object, by individual participants may be determined and analyzed. Regardless of the exact nature of information that is decoded from the card 202, the decoded information may be used by processor 208 to generate a graphical representation of feedback from participants or other suitable output.

In some embodiments, the graphical representation of the responses may be displayed on a personal display 210, which may be shown only to an administrator. Alternatively or additionally, the graphical representation of the responses may be displayed on an external display 212, which may be shown to the participants themselves, or to any other suitable party. The external display 212 may be at the same location as computer 206 and/or the participant holding the response card 202, although the invention is not limited to any particular location or number of displays.

In addition or as an alternative to displaying a graphical representation of the participants' feedback, any suitable representation of the feedback may be generated and output by the feedback system. Examples of possible representations include, but are not limited to, a numerical table, a textual summary, or the captured image or video itself. Furthermore, the representation may be output by any suitable techniques, such as projecting on a display, printing on paper, or transmitting via a communication medium. It should be appreciated that once the feedback has been gathered and decoded, the exact nature of how the feedback is represented and presented is not critical to the invention.

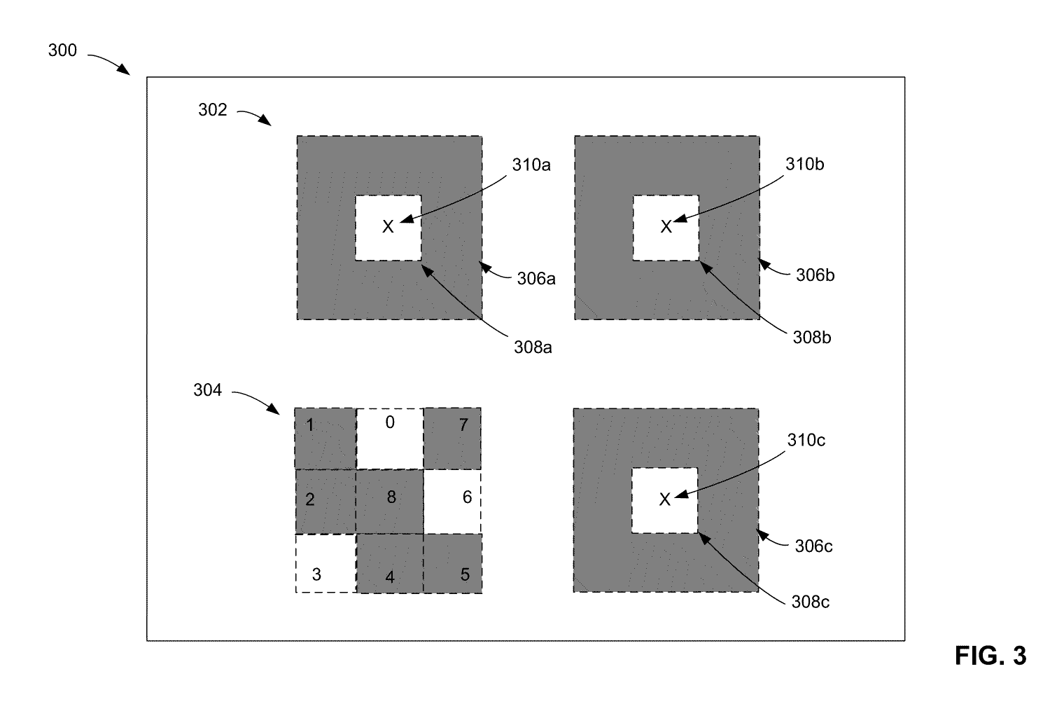

FIG. 3 is a sketch illustrating an exemplary encoding scheme for an object, such as response card 300, usable by a participant to present feedback. Response card 300 may be visually encoded with various types of information. For example, the visual encodings may be designed to facilitate locating the card 300 within an image, locating information within the card 300, and/or decoding the located information.

In some embodiments, the response card 300 may have at least one region 302 with a predetermined pattern. The region 302 may comprise one or more shapes, such as the three boxes spanning the top and right areas of card 300 in FIG. 3, although the exact nature and number of shapes in region 302 is not critical to the invention. The card 300 may also have an encoded portion 304, which may indicate a code representing a response and an identifier of a participant holding the card 300.

The region 302 may be designed to identify the response card 300 in an image. For example, the region 302 may have different shapes, each shape having a first sub-region with a first visual characteristic and a second sub-region with a second visual characteristic distinguishable from the first visual characteristic. For example, in FIG. 3, each of the three boxes in region 302 has a dark outer region, 306a, 306b, 306c, respectively, surrounding a contrasting white inner region, 308a, 308b, 308c, respectively. It should be appreciated, however, that the exact nature of the first and second sub-regions in each shape is not critical to the invention.

Regardless of their particular shape or color, the outer and inner sub-regions of each box in region 302 may be designed such that inner and outer sub-regions have coincident centroids. For example, in FIG. 3, the upper left-hand box has an outer sub-region 306a and an inner sub-region 308a, both of which have the same centroid, located at 310a. Similarly, the other two boxes in region 302 have centroids 310b and 310c.

By designing the region 302 in such a manner, a response card 300 can be identified by a computer searching for three such pairs of contrasting inner and outer sub-regions having the same centroids. The inner and outer sub-regions may be designed such that their centroids remain coincident, invariant to skewing and tilting of the card 300. This may be desirable to achieve robust identification of the pattern in region 302, regardless of non-ideal positioning, orientation, or rotations of the card 300 in a captured image.

In addition to identifying the response card 300 in a captured image, the region 302 may also be used to locate the encoded portion 304 within the card 300. In some embodiments, the alignment of the three centroids, 310a, 310b, and 310c, may be used to calculate the location, orientation, and rotation of the encoded portion 304. In the example of FIG. 3, the three centroids, 310a, 310b, and 310c, represent three of the four corners of a larger square. The encoded portion 304 may therefore be located by finding the fourth corner of the square outlined by the three centroids.

The encoded portion 304 may encode information about the response and/or participant's identity. In some embodiments, the encoded portion 304 may contain a binary code, although the code may be based in any suitable numeric system. For example, FIG. 3 illustrates an encoded portion 304 encoding a 9-bit sequence in a grid of nine squares. The nine squares may represent the binary bits of a 9-bit code. The coding may be designed in any suitable manner, for example, the square closest to the center may represent bit 7, and bits 6 through 0 may be found by counting clockwise around the central square which may represent bit 8.

The example in FIG. 3 illustrates a 9-bit encoded portion 304 corresponding to the binary code 110110110, or 438 in decimal notation. By using black or white shading for each of the nine squares in the encoded portion 304, different binary codes may be realized. Although the example in FIG. 3 encodes a 9-bit code on the card 300, this may be extended to encode a greater or fewer number of bits, depending on the size of the audience and/or the desired robustness of error-checking.

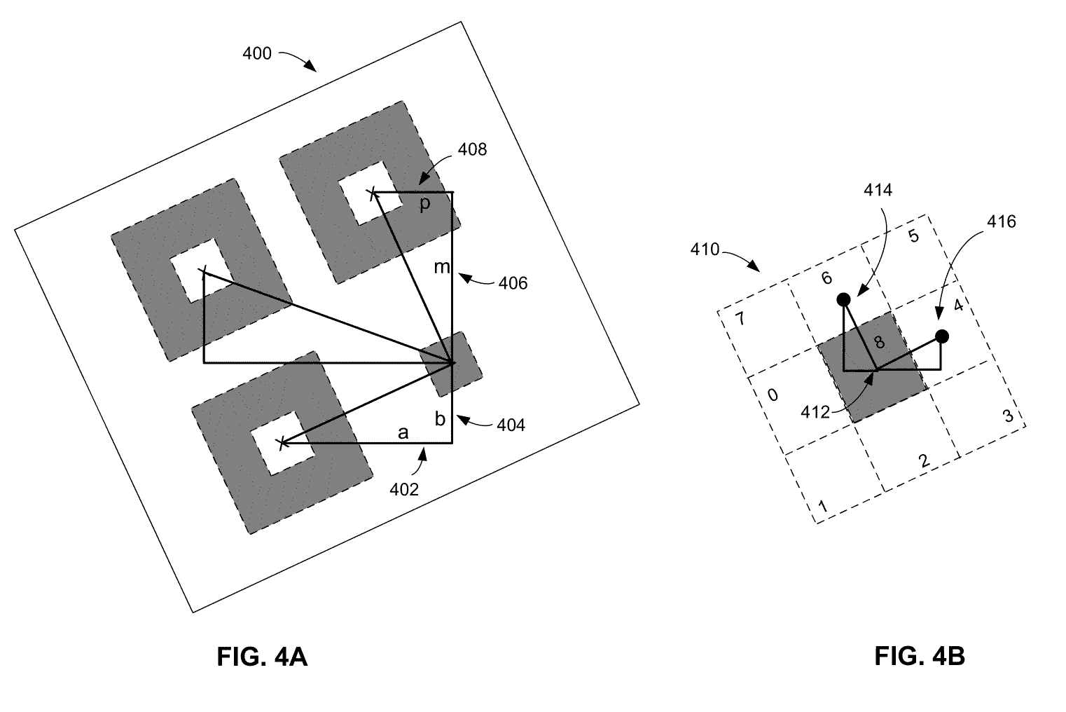

FIGS. 4A and 4B illustrate the procedure of reading each of the nine bits from the encoded portion on a response card 400. Once the centroids of the three boxes have been identified in FIG. 3, the relative distances between the centroids gives details about the orientation and rotation of the card in three dimensions. Having determined the orientation and rotation of the card 400, the encoded portion may be located and the centers of the squares representing the 9 bits may be located for processing.

The algorithm described can process an image, such as a video stream or static image, taken from a camera source or a file directory. For example, a video stream may be processed as a series of images. In each image, the algorithm searches for card objects in the frame by first locating three centroids within a certain range of each other, and then projecting calculated distances into a fourth quadrant to locate the encoded portion. In such a way, the algorithm accounts for relative rotations and skews representing non-ideal presentations of the cards.

A basic outline for an illustrative embodiment of the algorithm is described in Table 1, including the identification of response cards within a captured image, followed by the decoding of information within the identified cards.

TABLE 1
Algorithm for Identifying and Decoding Response Cards in an Image

| | |
|---|---|
| 1. | Scan the image looking for all concentric black and white pairs |
| | within a range of error constituting a “target.” |
| 2. | Group sets of three targets within a range of error of each other |
| | constituting a “card” |
| 3. | Calculate relative rotations and skews based on the distance |
| | between the center of each target and use that calculation to |
| | estimate the location of the center of the fourth quadrant |
| 4. | Use the projection numbers to estimate the locations of the |
| | center of bits 8 through 0 |
| 5. | For the center of each bit, if the pixel is “black,” then define it |
| | as a 1 in the binary code; otherwise, define it as a 0 |
| 6. | Inversions and orientations are accounted for which reorganize |
| | the bits into the proper order, and the code is read and returned |
| | for individual use and/or further processing |

As a more specific example, a card may be identified as follows. First, the captured image may be scanned line-by-line to find connected components, which may be defined as adjacent pixels having the same color and may be identified using any suitable techniques, including techniques as are known in the art. Given a list of all connected components, the centroid of the component may be calculated, based on weighted values of width and height of the component. Then, a comparison may be performed between all centroid values of black components and white components. If a black centroid is within a tight range of a white centroid, then the two are defined as a pair, and each pair is defined as a “target.” Given a list of all targets, a grouping occurs of any set of three targets that are within a predefined range of each other, thus defining a “card.”

In this example, given a list of groups of targets, unit distances are calculated between the centers to determine the orientation of the card in order to estimate the center of the fourth quadrant. FIG. 4A shows the calculations and projections to find the center of the encoded portion. The variables a, b, p, and m represent the relative distances, 402, 404, 406, and 408, respectively, between centroids in a rotated image of card 400. In an ideal case, b and p are zero, while a and m represent the real distance between the centroids and the center of the encoded portion. However, in real-life scenarios, all four variables may be needed to calculate the locations of the seven bits. The distances to the upper-left-hand triangle are redundant and may be ignored to reduce processing efforts.

FIG. 4B illustrates how the centers of the nine bit locations in encoded portion 410 may be estimated using the four variables identified in FIG. 4A. In this example, bits 4 and 6 illustrate the approach of locating areas of an image representing a bit of information encoded on a response card. Consider the center 412 of the encoded portion 410, located at coordinate (x_{c},y_{c}), which was determined in FIG. 4A and represents the center of bit 8. Relative to location (x_{c},y_{c}), the coordinates of the center of bit 6, denoted 414, may be calculated by using the formula (x_{c}−p/4, y_{c}−m/4). Similarly for bit 4, the coordinates of center 416 may be calculated as (x_{c}+a/4, y_{c}+b/4). Table 2 lists the calculations for all 9 bits.

TABLE 2
Calculating Locations of Bits in the Encoded Portion of a Response Card

| Bits | Formula |
|---|---|
| 8 | (x_{c}, y_{c)} |
| 7 | (x_{c} − a/4 − p/4, y_{c} − b/4 − m/4) |
| 6 | (x_{c} − p/4, y_{c} − m/4) |
| 5 | (x_{c} + a/4 − p/4, y_{c} + b/4 − m/4) |
| 4 | (x_{c} + a/4, y_{c} + b/4) |
| 3 | (x_{c} + a/4 + p/4, y_{c} + b/4 + m/4) |
| 2 | (x_{c} + p/4, y_{c} + m/4) |
| 1 | (x_{c} − a/4 + p/4, y_{c} − b/4 + m/4) |
| 0 | (x_{c} − a/4, y_{c} − b/4) |

Once the locations of the bits have been determined, the black/white shading of each square indicates the value of the corresponding bit. Upon determining the binary value of the code, the decimal value may then be mapped to a response and identifier of a participant. The number of participants and response options may be determined by the encryption used. For example, with a 9-bit code with no error checking, 100 participants could have 5 different response options, by using 500 of the 512 available 9-bit coded values. Alternatively, if responses are encoded using rotation and the binary encoding solely identifies the participant, 512 participants could have 4 different response options corresponding to the four discrete rotations of the card.

It should be appreciated, however, that the foregoing description is just one possible method of determining the information encoded in a response card, and the invention is not necessarily limited to any particular encoding and decoding strategy. Regardless of the exact nature of the encodings on a response card and the calculations used to determine the values of the encodings, a participant's identity and response may be anonymously encoded on an object, for example a response card, such that it can be imaged and reliably decoded, invariant to tilts and skews of the card in the captured image.

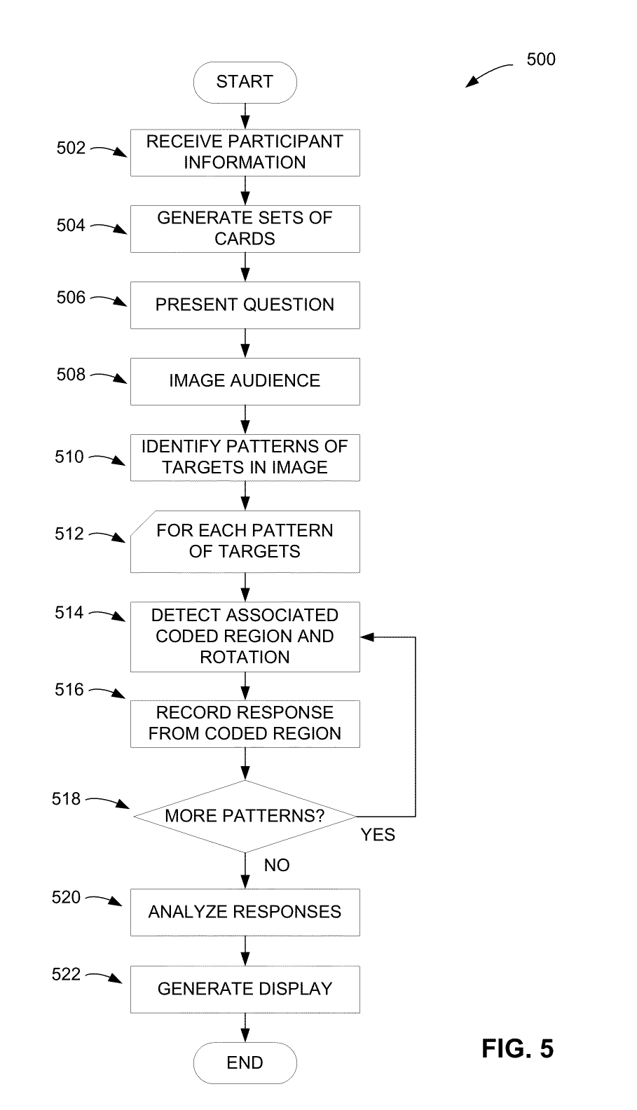

FIG. 5 is a flowchart of an exemplary method 500 of operation of a system for collecting and analyzing feedback. In particular, the method 500 describes the actions taken by administrators and participants in using the feedback system to collect and analyze feedback from the participants.

In act 502, the administrator, or any suitable party, receives information about the participants. Such information may include, but is not limited to, a name, an identification number, or any appropriate personal information that may be relevant to analyzing feedback collected from the participant.

In act 504, this personal information is then used to generate a set of cards for each participant. In some embodiments, the set of cards may represent a set of possible responses to questions. It should be appreciated, however, that the invention is not necessarily limited to question-and-answer settings, and the set of cards provided to a participant may generally represent any appropriate set of information that is relevant to the participant's feedback. The cards may be encoded with any suitable information, as described in FIGS. 3, 4A, and 4B, including the participants' identity and a response. The cards may then be distributed to the participants.

In act 506, the administrator may then present a question to the audience of participants. The question may be, for example, a multiple-choice question, or a poll, or any suitable question or other prompt that elicits feedback from the participants. The question or other prompt may be directed to the entire audience, or may be directed to a particular subset of the audience.

In act 508, an image of the audience's responses may be captured by an imaging device. An image may be taken of the entire audience, or the relevant subset of the audience, by a single imaging device. Alternatively, multiple imaging devices may be used to capture different portions of the audience. Regardless of the exact nature and number of imaging devices, an image of the participants' response cards may be captured.

In act 510, the imaging device, or any suitable computing device, may identify patterns of targets constituting a response card in the captured image. The identification of targets and cards may be performed by looking for a particular pattern of shapes and colors, an example of which was as previously described in relation to steps 1 and 2 of the algorithm outlined in Table 1. Once a pattern of targets has been identified to be a valid response card, the process 500 proceeds to decode information within the card.

Act 512 is the beginning of a processing loop for each identified pattern of targets, or card, in the captured image. In act 514, a coded region is detected within an identified card based on its position relative to the pattern of targets. The rotation of the found card may be calculated from the relative positions of the targets. For example, the coded region may be encoded portions 304 in FIGS. 3 and 410 in FIG. 4B. The location of such a coded region may be detected on the card by using one or more other regions printed on the response card, such as the three pairs of concentric squares in region 302 of FIG. 3 and FIG. 4A. For example, one possible algorithm for detecting a coded region was previously described in relation to FIG. 4A.

Once the coded region has been detected, in act 516, information that is encoded in the coded region may be determined and recorded. For example, one possible method of decoding information was previously described in relation to FIG. 4B, whereby a nine-bit sequence was determined from black/white shadings surrounding a central square. Information decoded from the coded region may be used to determine an identity of a participant and a response of the participant.

In act 518, the computing device executing method 500 determines whether there are more patterns, or cards, to be analyzed in the captured image. If so, then the process returns to act 514 to detect a coded region in another response card. Otherwise, if there are no further detected patterns in the image that indicate a response card, then the process proceeds to act 520 to analyze the responses collected from the participants.

Analyzing the responses may involve any number of suitable actions, such as determining which participants have or have not responded, in addition to analyzing any trends or statistics in the responses. The analysis may involve responses of the entire audience or a subset of the audience, including individual participants.

Once the responses have been collected and analyzed in act 520, then in act 522, a suitable representation of the responses may be generated. For example, a graphical representation may be presented on a display to an administrator and/or the participants. Alternatively or additionally, any suitable representation of the analysis may be generated and presented or distributed in any suitable manner.

In some embodiments, after identifying and decoding all the responses in the captured image, the algorithm may determine that the responses for some participants were not recorded. This may occur either because some participants did not respond, or because their responses were not clearly captured in the image(s). In such a scenario, the process 500 may have an option to re-take an image of the participants' responses. For example, the imaging device may be adjusted, moved, or re-calibrated, and the process 500 may return to act 506 to re-start the poll and generate another image of the responses. This process may continue any number of times to collect the appropriate number of responses from the audience.

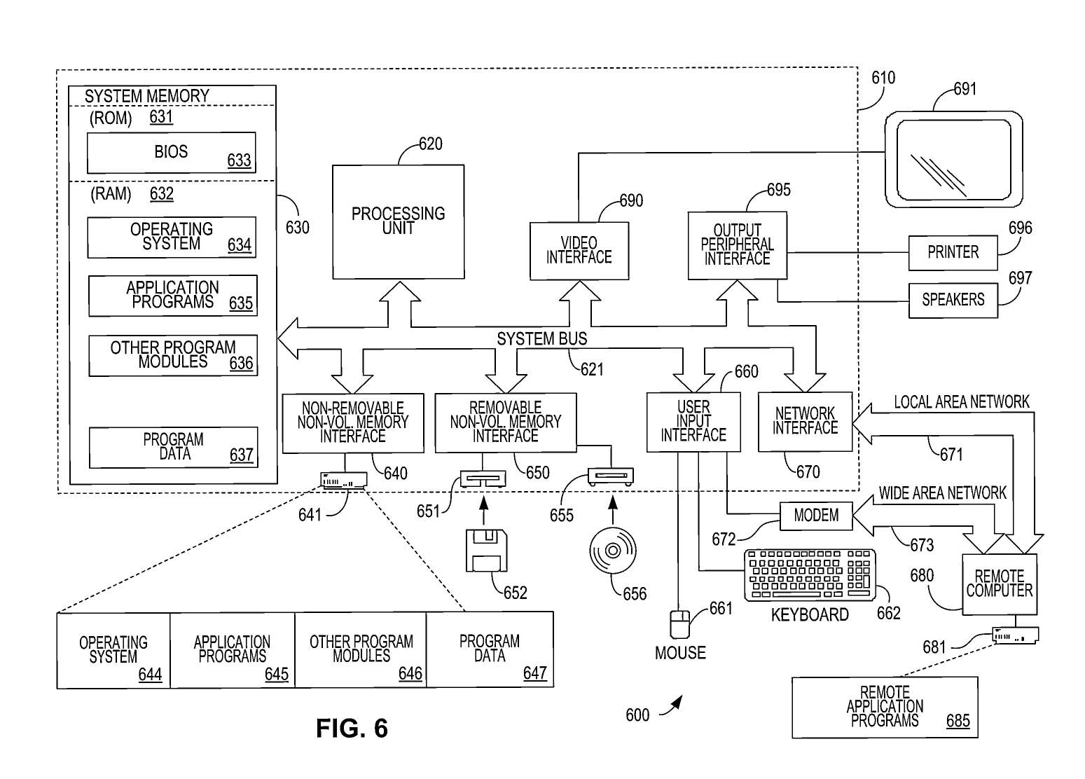

Method 500, and other processing in according with techniques described herein, may be performed in any suitable computing device. FIG. 6 is a sketch of an exemplary computing system on which all or parts of feedback system may be implemented. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the exemplary operating environment 600.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 6, an exemplary system for implementing the invention includes a general purpose computing device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through an non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through a output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of obtaining feedback from a plurality of participants, the method comprising:
with at least one processor, analyzing an image of the participants, the analyzing comprising:
identifying in the image a plurality of objects, the plurality of objects being visually encoded with responses from the plurality of participants; and
for each of the plurality of identified objects, determining from encoding on the object a response and an identifier of a participant of the plurality of participants.

2. The method of claim 1, wherein the analyzing further comprises:
generating a graphical representation of aggregated responses in the plurality of identified objects.

3. The method of claim 2, further comprising:
displaying the graphical representation to the plurality of participants.

4. The method of claim 1, wherein the analyzing further comprises:
identifying participants of the plurality of participants for which a response was not identified.

5. The method of claim 1, wherein:
the plurality of objects comprise a plurality of response cards, each of the plurality of response cards comprising:
at least one region having a predetermined pattern; and
an encoded portion having a code representing at least an identifier of a participant of the plurality of participants.

6. The method of claim 5, wherein:
the at least one region comprises at least one shape comprising:
a first sub-region having a first visual characteristic; and
a second sub-region with a second visual characteristic, distinguishable from the first visual characteristic, the first sub-region and the second sub-region having coincident centroids.

7. The method of claim 6, wherein:
the at least one shape comprises a plurality of shapes disposed in a pattern;
the encoded portion has a predetermined position with respect to the plurality of shapes; and
determining from encoding on the object a response and an identifier of a participant of the plurality of participants comprises decoding the encoding and determining a rotational orientation of the object.

8. The method of claim 1, further comprising:
printing, for each of the plurality of participants, a respective set of response cards, each set of response cards being encoded with one of a plurality of responses and an identifier of a respective participant.

9. A system for obtaining feedback from a plurality of participants, the system comprising:
a camera; and
at least one processor configured to analyze an image acquired by the camera, the analyzing comprising:
identifying in the image a plurality of objects, the plurality of objects being visually encoded with feedback from the plurality of participants; and
for each of the plurality of identified objects, determining from encoding on the object a response and an identifier of a participant of the plurality of participants.

10. The system of claim 9, wherein:
the system further comprises an output device; and
the at least one processor is further configured to generate on the output device a display based on the determined responses for the plurality of identified objects.

11. The system of claim 10, wherein:
the output device is a screen on a computing device configured for private review by a person presenting to the plurality of participants.

12. The system of claim 10, wherein:
the output device is configured for presentation of the display to the plurality of participants.

13. The system of claim 9, wherein:
the plurality of objects comprise a plurality of response cards,
each of the plurality of response cards comprising:
a plurality of regions, each region having a predetermined pattern with the plurality of regions being disposed in a predetermined pattern; and
an encoded region, the encoded region having visual characteristics indicative of response and an identifier of a participant.

14. The system of claim 9, comprising a mobile phone, wherein the camera and the at least one processor are components of the mobile phone.

15. At least one computer-readable storage medium encoded with computer-executable instructions for performing a method comprising:
analyzing an image of a plurality of participants, the analyzing comprising:
identifying in the image a plurality of objects, the plurality of objects being visually encoded with feedback from the plurality of participants; and
for each of the plurality of identified objects, determining from encoding on the object a response and an identifier of a participant of the plurality of participants.

16. The at least one computer-readable storage medium of claim 15, wherein the computer-executable instructions further comprise instructions for controlling a camera to capture the image.

17. The at least one computer-readable storage medium of claim 16, wherein the computer-executable instructions for controlling the camera to capture the image comprises computer-executable instructions for controlling the camera to capture a video image.

18. The at least one computer-readable storage medium of claim 16, wherein:
the computer-executable instructions are adapted for execution on a mobile phone; and
the computer-executable instructions for controlling the camera to capture the image comprise computer-executable instructions for controlling the camera of the mobile phone.

19. The at least one computer-readable storage medium of claim 15, wherein the computer-executable instructions further comprise instructions for receiving information indicating the plurality of participants.

20. The at least one computer-readable storage medium of claim 19, wherein the computer-executable instructions further comprise instructions for controlling a printer to print a plurality of response cards, each response card visually encoded with a response and an identifier of a participant of the indicated plurality of participants.
